(19) United States
(12) Patent Application Publication
(10) Pub. No.: US 2008/0031640 A1
(43) Pub. Date: Feb. 7, 2008

(54) Method Of Calibrating Alignment Section, Image-Drawing Device With Calibrated Alignment Section, And Conveying Device

(75) Inventor: Takashi Fukui, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/632,942

(22) PCT Filed: Sep. 29, 2005
(86) PCT No.: PCT/JP05/18500

§ 371 Date: Jan. 19, 2007

(30) Foreign Application Priority Data
Sep. 29, 2004 (JP) 2004284666

(51) Int. Cl. G03G 15/00

(52) U.S. Cl. 399/9; 399/205

(57) ABSTRACT

An alignment section calibration system used in a device which handles elongated, flexible recording media, has an alignment section, a calibration member, and a relative moving mechanism. The alignment section is disposed so as to be able to carry out detection at a position of an area at which alignment is carried out and which is set on a conveying path, at a time when image-drawing is carried out by an image-drawing unit while a flexible recording medium is conveyed in a given conveying direction on a conveying path which is set at a conveying section for scanning. The calibration member disposed at a position further toward the alignment section than the conveying path. The relative moving mechanism relatively moves the alignment section and the calibration member, such that the alignment section is set in a state of detecting the calibration member.

### BACKGROUND OF THE INVENTION

1. Field of the Invention

The present invention relates to a method of calibrating an alignment section, and to an image-drawing device in which alignment can be calibrated, and to a conveying device.

2. Description of the Related Art

Examples of image-drawing devices which are generally used include exposure devices such as printed board (flexible substrate) exposure devices, laser photoplotters, and laser printers. These devices are scanning-type exposure devices which draw a desired image on a recording medium by scanning the recording medium by a light beam.

In such an exposure device, for example, in the case of a printed board exposure device, image-drawing is carried out by scanning laser light on a substrate material for a printed wiring board, which is the recording medium. The substrate material for a printed wiring board which is used here is structured by forming a conductive thin film on an insulating layer, and covering this conductive thin film with a photoresist.

The printed board exposure device scans laser light, which is modulated on the basis of image data, on such a substrate material. The desired substrate pattern is thereby exposed on the photoresist layer.

The substrate material for a printed wiring board, which has been subjected to exposure processing in this way, is removed from the printed board exposure device, and is subjected to a photoetching processing, and is thereby completed as a printed board.

In a conventional printed board (flexible substrate) exposure device which is used in this way, an elongated, strip-shaped recording medium (the flexible substrate) is stretched between a loader, which feeds-out the recording medium which is in the form of a rolled sheet, and an unloader, which is for collecting the recording medium. This stretched portion of the recording medium is placed and fixed on an image-drawing surface of an image-drawing table by a fixing means, and in this state, the image-drawing table can be slid with high accuracy by a sliding means. Further, a scanning optical system which scans the laser light is disposed directly above the recording medium which stretches between the loader and the unloader.

While the image-drawing table, on whose image-drawing surface the stretched portion of the recording medium is fixed by the fixing means, is conveyed highly accurately by the sliding means, the scanning optical system carries out image-drawing by scanning laser light, which is modulated on the basis of image data, on the medium which is slid highly accurately together with the image-drawing table.

In this conventional printed board exposure device, after the first image-drawing processing is completed, in order to start image-drawing processing again, the fixing means of the image-drawing table is released, and the recording medium is fixed by a clamping roller pair of the loader and is fixed by a driving roller pair of the unloader, such that the recording medium stretched between the loader and the unloader is set in an immobile state. Thereafter, the image-drawing table is moved toward the loader by the sliding means. Next, the recording medium is fixed on the image-drawing surface of the image-drawing table by the fixing means of the image-drawing table.

Subsequently, the clamping roller pair of the loader is released, and the recording medium is drawn-out such that slack arises thereat, by a pair of drawing-out rollers of the loader. Then, while the image-drawing table is moved toward the unloader by the sliding means, the recording medium fixed on the image-drawing surface of the image-drawing table is scanned by the scanning optical system, and the recording medium is collected in the unloader by a driving roller pair of the unloader, so as to complete the next image-drawing processing. Note that the above-described operations are repeated the needed number of times when a subsequent image-drawing processing is carried out. Refer to, for example, Japanese Patent Application Laid-Open (JP-A) No. 2000-235267.

Such a conventional printed board (flexible substrate) exposure device is usually provided with an aligning means for adjusting the alignment such that a predetermined pattern can be drawn highly accurately on the elongated, strip-shaped recording medium. In such an aligning means, for each type of elongated, strip-shaped recording medium having different positions where the alignment marks are provided, position calibration of the aligning means must be carried out by using a calibration scale disposed on the image-drawing table in correspondence with the image-drawing position of the elongated, strip-shaped recording medium.

However, in the above-described, conventional printed board (flexible substrate) exposure device, image-drawing processing is always carried out in a state in which the elongated, strip-shaped recording medium is spanning and there are no obstructive members between the elongated, strip-shaped recording medium and the scanning optical system which scans the laser light. Therefore, the conveying path for the elongated, strip-shaped recording medium must be provided on the calibration scale disposed on the image-drawing table.

Therefore, in the state in which the elongated, strip-shaped recording medium is set on the conveying path, the calibration scale for carrying out position calibration of the aligning means is hidden beneath the elongated, strip-shaped, flexible recording medium. Therefore, when carrying out image-drawing processing on plural types of substrates, at which the alignment mark positions are different, in a single, elongated, strip-shaped, flexible recording medium, position calibration of the aligning means cannot be carried out by using the calibration scale for each elongated, strip-shaped recording medium of a type in which the positions at which the alignment marks are provided are different.

Accordingly, an issue in the above-described, conventional printed board (flexible substrate) exposure device is image-drawing processing while carrying out alignment adjustment highly accurately by calibrating the position of the aligning means by using the calibration scale for each elongated, strip-shaped recording medium of a type in which the positions where the alignment marks are provided differ.

### SUMMARY OF THE INVENTION

A first aspect of the present invention is a method of calibrating an alignment section. The method includes, in a state in which alignment is adjusted by an alignment section and image-drawing is carried out while one, elongated, flexible recording medium which includes plural types of alignment mark positions is conveyed, restraining the flexible recording medium on a conveying path of an image-drawing unit, at a time when the alignment mark positions on the flexible recording medium become different positions. The method also includes relatively moving a calibration member and the alignment section, so as to make the calibration member and the alignment section correspond to one another. The method also includes, calibrating data of a reference position of the alignment section by using the calibration member.

In accordance with the above-described method of calibrating an alignment section, even when the elongated, flexible recording medium cannot be removed from the conveying path of the conveying section for scanning because it is in the midst of carrying out exposure processing on the flexible recording medium which is formed as a single, elongated body and which includes plural types having different positions where alignment marks are provided, alignment adjustment is carried out with high accuracy and image-drawing processing can be carried out, after the position of the alignment section is calibrated by using the calibration member for each type at which the positions where the alignment marks are provided are different.

A second aspect of the present invention is an image-drawing device in which alignment can be calibrated. The image-drawing device carries out image-drawing at an image-drawing unit while conveying an elongated, flexible recording medium in a given conveying direction on a conveying path set at a conveying section for scanning, and the image-drawing device has: an alignment section disposed so as to be able to carry out detection at a position of an area at which alignment is carried out and which is set on the conveying path of the conveying section for scanning on which the elongated, flexible recording medium is conveyed; a calibration member disposed at a position further toward the alignment section than the conveying path; and a relative moving mechanism relatively moving the alignment section and the calibration member, such that the alignment section is set in a state of detecting the calibration member.

In accordance with the above-described structure, even when the elongated, flexible recording medium cannot be removed from the conveying path of the conveying section for scanning because it is in the midst of carrying out exposure processing on the flexible recording medium which is formed as a single, elongated body and which includes plural types having different positions where alignment marks are provided, alignment adjustment is carried out with high accuracy and image-drawing processing can be carried out, after the position of the alignment section is calibrated by the relative moving mechanism making the alignment section and the calibration member, which is disposed at a position further toward the alignment section than the conveying path, correspond to one another.

A third aspect of the present invention is a method of calibrating an alignment section. This calibration method is a method of calibrating an alignment section in a conveying device of an elongated, flexible recording medium, and includes, in a state in which the flexible recording medium is set at a conveying path, relatively moving the alignment section and a calibration member, which is disposed at a position further toward the alignment section than the conveying path, and making positions of the alignment section and the calibration member correspond to one another; and carrying out position calibration of the alignment section by using the calibration member.

A fourth aspect of the present invention is a conveying device. This conveying device is a conveying device of an elongated, flexible recording medium, and has: a conveying section conveying the flexible recording medium in a given conveying direction; an alignment section disposed so as to be able to carry out detection at a position of an area at which alignment is carried out and which is set on a conveying path along which the flexible recording medium is conveyed by the conveying section; a calibration member disposed at a position further toward the alignment section than the conveying path; and a relative moving mechanism relatively moving the alignment section and the calibration member, such that the alignment section is set in a state of detecting the calibration member.

### BRIEF DESCRIPTION OF THE DRAWINGS

FIG. 1 is a perspective view showing a schematic structure of main portions of an image-drawing device relating to an embodiment of the present invention.

FIG. 2 is a front view showing the schematic structure of the main portions of the image-drawing device relating to the embodiment of the present invention.

FIG. 3 is a schematic structural view of main portions showing a state in which a conveying section for scanning equipped with a unit for detection, of the image-drawing device relating to the embodiment of the present invention, is moved to a position for alignment camera calibration.

FIG. 4 is a schematic structural view of main portions showing a state in which the conveying section for scanning equipped with a unit for detection, of the image-drawing device relating to the embodiment of the present invention, is moved to a position for beam position detection.

FIG. 5 is a schematic structural view of main portions showing a state in which the conveying section for scanning equipped with a unit for detection, of the image-drawing device relating to the embodiment of the present invention, is moved to a position for exposure surface power calibration.

FIG. 6 is a schematic enlarged structural view of main portions showing a structural example in which guides for an endless belt are provided at a conveying path portion of an exposure processing section in the image-drawing device relating to the embodiment of the present invention.

FIG. 7 is a plan view of main portions showing an example of a flexible printed wiring board material subjected to exposure processing at the image-drawing device relating to the embodiment of the present invention.

### DETAILED DESCRIPTION OF THE INVENTION

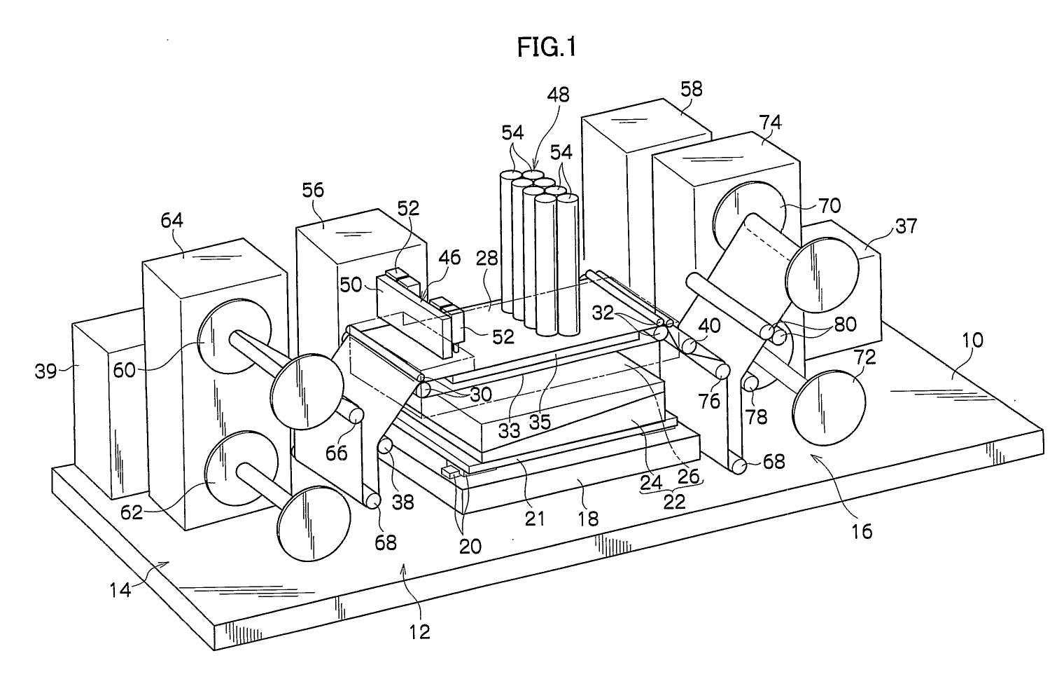

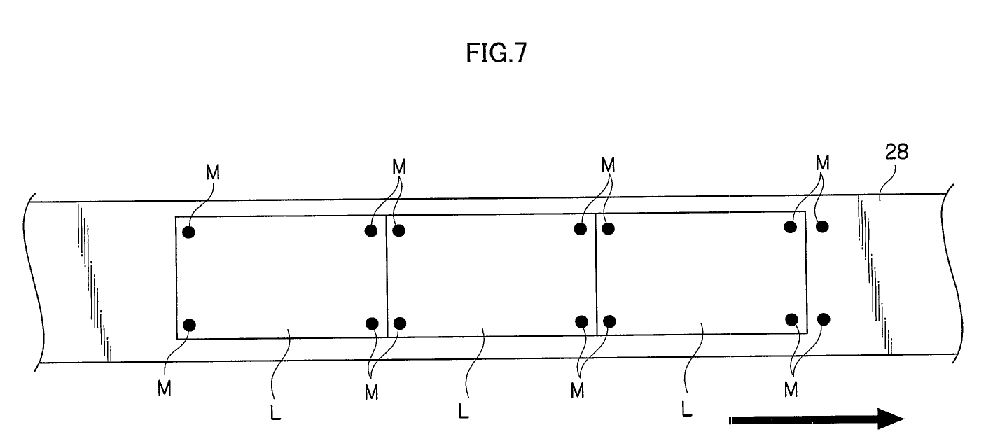

An embodiment relating to an image-drawing device of the present invention will be described with reference to FIGS. 1 through 7.

The image-drawing device relating to the embodiment of the present invention is structured as a flexible printed wiring board exposure device which is automatically controlled by a control unit and which, while moving in a scanning direction a flexible printed wiring board material which is a flexible recording medium formed as an elongated, strip-shaped sheet, spatially modulates a multibeam emitted from a light source on the basis of a modulation signal generated at the control unit from image data, and irradiates the spatially-modulated multibeam onto the flexible printed wiring board material, thereby carrying out exposure processing.

As shown in FIG. 1, in this image-drawing device, an exposure processing section 12 is disposed at the central portion of a floor base 10. An unexposed recording medium supplying section 14 is disposed at one side portion (the left side portion in FIG. 1) of the exposure processing section 12. An exposed recording medium collecting section 16 is disposed at the other side portion (the right side portion in FIG. 1) of the exposure processing section 12.

At the exposure processing section 12, a substrate conveying section 22 is mounted, via a linear moving mechanism 20, on the flat surface of a device stand 18 having a vibration-isolating function, which is disposed on the floor base 10.

The linear moving mechanism 20 is structured such that a linear motor or another feeding means is mounted between the top planar portion of the device stand 18 having a vibration-isolating function, and a moving table 21 to which the substrate conveying section 22 is mounted.

When the linear moving mechanism 20 is structured by a linear motor for example, an unillustrated, rod-shaped stator portion (magnet portion) is provided along the conveying direction at the device stand 18 having a vibration-isolating function. A coil portion (not shown), which is disposed at the bottom surface side of the moving table 21, is provided. Due to the driving force caused due to the workings of the magnetic field of the stator portion and the magnetic field generated by the coil portion being energized, the linear motor moves the moving table 21 in the conveying direction.

The linear motor can, with high accuracy and by electric control, drive and control constancy of speed, positioning accuracy, torque fluctuations at the time of starting and stopping, and the like in the conveying operation of the substrate conveying section 22.

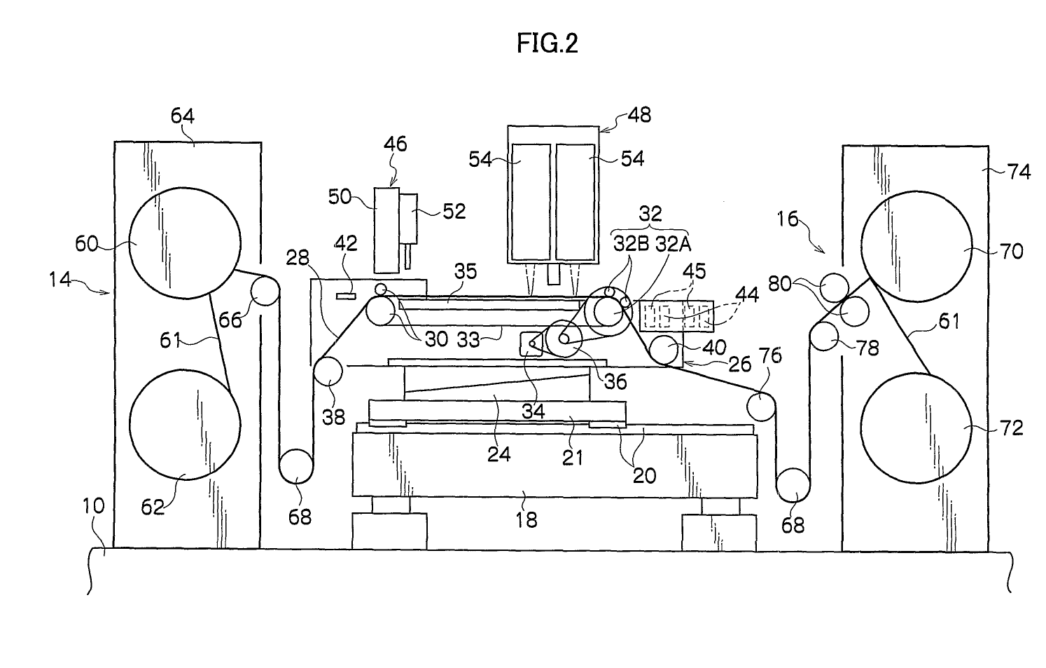

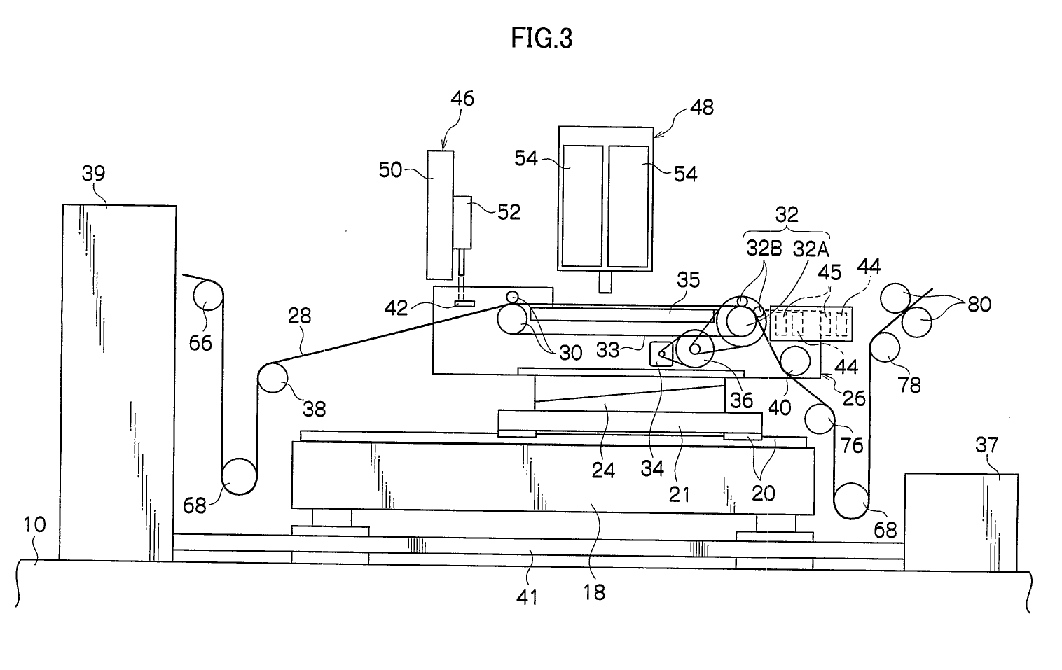

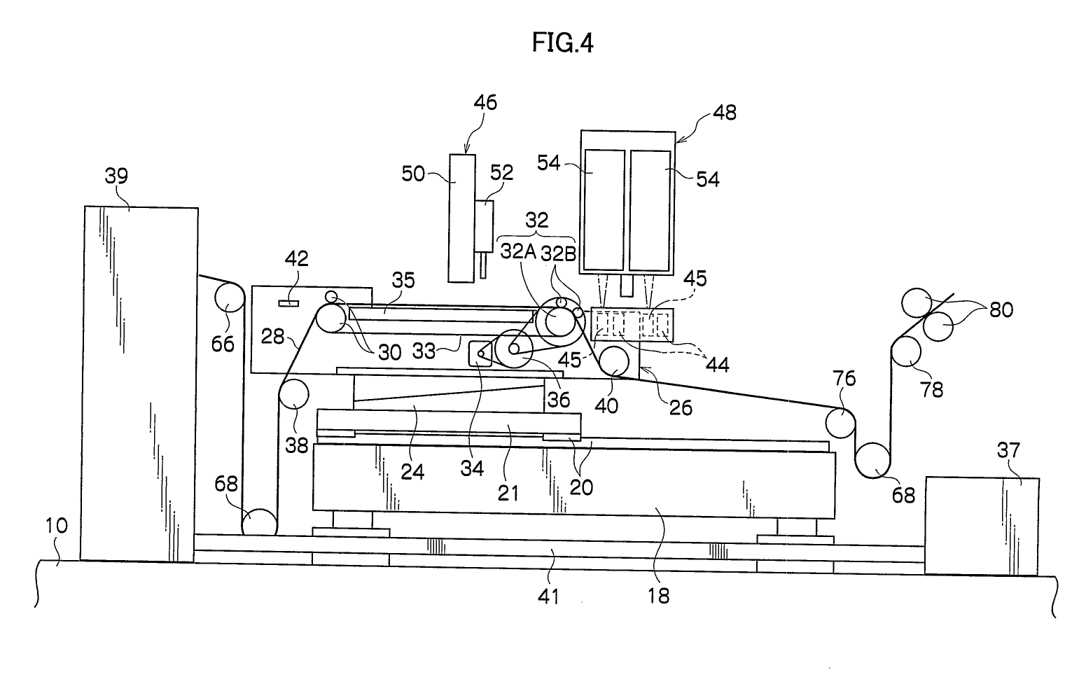

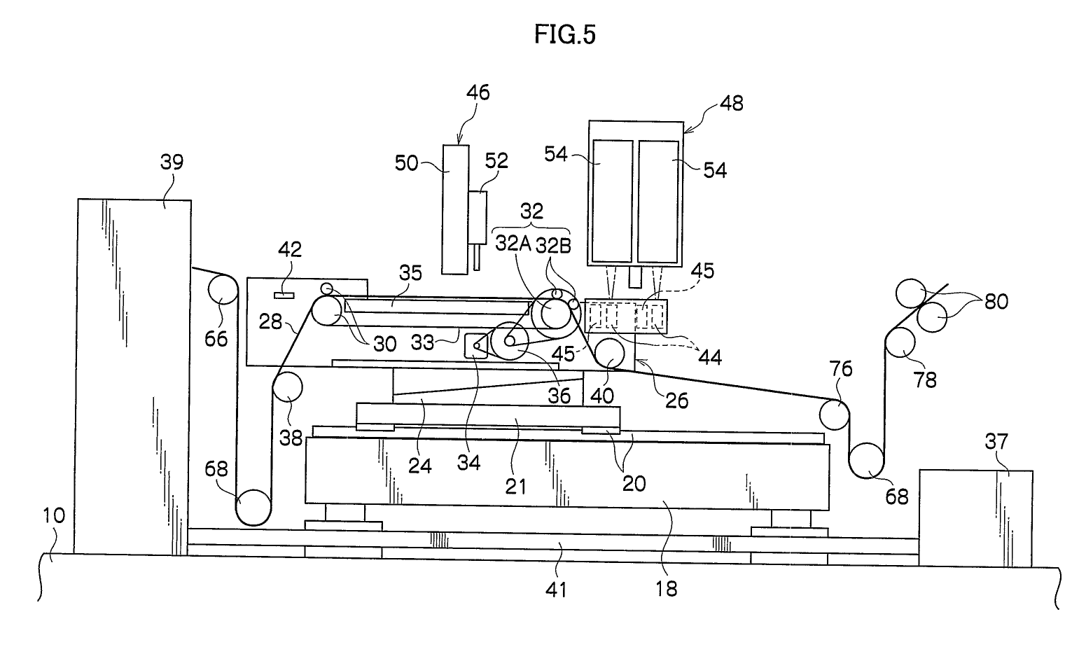

Due to the linear moving mechanism 20 moving the entire substrate conveying section 22 upstream or downstream in the conveying direction of a flexible printed wiring board material 28, the substrate conveying section 22 can move from an exposure processing position shown in FIG. 1 and FIG. 2, to a position for alignment camera calibration shown in FIG. 3, or a position for beam position detection shown in FIG. 4 or a position for exposure surface power calibration shown in FIG. 5.

As shown in FIG. 1 and FIG. 2, the substrate conveying section 22 is structured as follows. A Z stage 24 for substrate thickness adjustment is set on the moving table 21. A conveying portion 26 for scanning equipped with a unit for detection is set on the Z stage 24 for substrate thickness adjustment.

In order to adjust the heightwise position of the exposure surface of the recording medium, the Z stage 24 for substrate thickness adjustment is structured so as to be able to move in parallel the entire conveying portion 26 for scanning equipped with a unit for detection, in the heightwise direction (the Z axis direction) by a fine movement adjusting mechanism using inclined surfaces.

As shown in FIG. 2, a belt conveying mechanism is mounted to the conveying portion 26 for scanning equipped with a unit for detection, in order to convey the flexible printed wiring board material 28 which is an elongated, strip-shaped, flexible recording medium. This belt conveying mechanism is structured by a nip roller pair 30 being disposed at the conveying direction upstream side, a nip driving roller pair 32 being disposed at the conveying direction downstream side, and an endless belt 33 being trained therebetween.

The nip driving roller pair 32 is structured by a plurality of (here, two) nip rollers 32B which rotate while contacting the outer peripheral surface of a driving roller 32A via the endless belt 33. The flexible printed wiring board material 28 is nipped between the driving roller 32A and the nip rollers 32B via the endless belt 33. By rotating the driving roller 32A, the endless belt 33 and the flexible printed wiring board material 28 are conveyed without slippage arising.

Rotating driving force of a predetermined rotational speed, which is outputted at a driving motor 34 and decelerated at a decelerating mechanism 36, is transferred to the driving roller 32A by a belt transfer mechanism. In this way, the nip driving roller pair 32 conveys the flexible printed wiring board material 28 at a predetermined scanning speed.

The nip roller pair 30, which is disposed at the conveying portion 26 for scanning equipped with a unit for detection, is structured such that two rollers rotate while contacting one another via the endless belt 33. Therefore, due to the flexible printed wiring board material 28 being held in a nipped state via the endless belt 33 between the nip rollers of the nip roller pair 30 and the nip roller pair 30 rotating, the endless belt 33 and the flexible printed wiring board material 28 are fed-out.

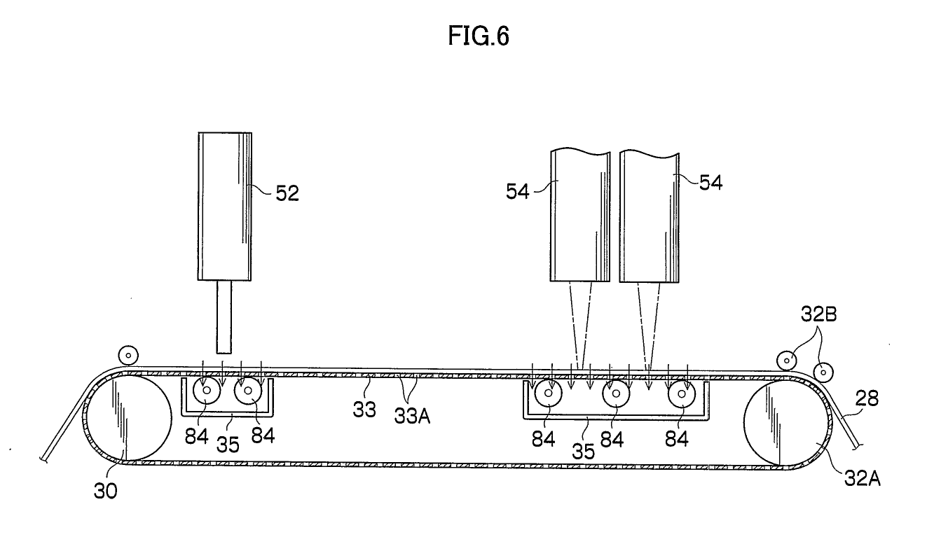

For example, as shown in FIG. 6, a large number of holes 33A for suction, which are circular through-holes, are formed in the endless belt 33 so as to be distributed uniformly.

A suction box 35 is provided at the conveying portion 26 for scanning equipped with a unit for detection. The suction box 35 structures a suction means, and is adjacent to the reverse side of the upper stretched portion of the endless belt 33 which is disposed along the conveying path in order for the flexible printed wiring board material 28 to be placed thereon.

The suction box 35 is disposed over a predetermined range which includes at least an area where alignment is carried out and an exposure area, which are the positions directly beneath an alignment unit 46 and an exposure head unit 48 which will be described later.

The suction box 35 which structures the suction means is formed in the shape of a rectangular box without a lid. Due to the suction box 35 being disposed next to the reverse side of the upper stretched portion of the endless belt 33, a semi-closed space for suction, which is enclosed by the endless belt 33 and the suction box 35, is formed.

At the suction means, the distal end portion of a suction tube (not shown), which is pulled-out from a blower 37, is connected to the suction box 35. The blower 37 which structures the suction means sucks the air which is within the semi-closed space enclosed by the endless belt 33 and the suction box 35, and sucks the air from the holes 33A for suction of the endless belt 33. Due to this operation, it is possible to carry out the operation of sucking the flexible printed wiring board material 28 to the surface of the endless belt 33.

In the conveying portion 26 for scanning equipped with a unit for detection which is structured in this way, due to the negative pressure suctioned from the respective holes 33A for suction of the endless belt 33 due to the blower 37 being driven and sucking the air within the semi-closed space enclosed by the endless belt 33 and the suction box 35, the portion of the flexible printed wiring board material 28, which portion has been conveyed-in from the nip roller pair 30 onto the conveying path of the exposure processing section 12, is suctioned to the endless belt 33. In this state, the flexible printed wiring board material 28 is conveyed integrally with the endless belt 33, and is conveyed-out from the nip driving roller pair 32.

While the flexible printing wiring board material 28 is being conveyed in this way from the nip roller pair 30 to the nip driving roller pair 32, the state of the flexible printing wiring board material 28 being suctioned to the endless belt 33 is maintained, and the flexible printing wiring board material 28 is conveyed continuously in a given conveying direction. Accordingly, at the conveying portion 26 for scanning equipped with a unit for detection, the flexible printed wiring board material 28 is placed on the endless belt 33, and exposure processing can be carried out while the endless belt 33 is driven continuously. Therefore, the operation of continuously carrying out exposure processing is always possible. This is related to an increase in the produceability of the exposure processing.

Further, at the conveying portion 26 for scanning equipped with a unit for detection, the flexible printed wiring board material 28 is made to run along the endless belt 33, which has high planarity, while tightly contacting the endless belt. Therefore, the focal length from the exposure head unit 48, which laser exposes the flexible printed wiring board material 28, can be held constant.

In particular, in a case in which the endless belt 33 is structured as a metal belt and not as a fabric belt, if the endless belt 33 is structured so as to be able to obtain an even higher planarity when a large tension is applied thereto, the planarity of the flexible printed wiring board material 28 suctioned on the endless belt 33 also is increased. Therefore, the focal length from the exposure head unit 48 is held constant with even higher accuracy.

In accordance with such a structure which makes the flexible printed wiring board material 28 run along the endless belt 33 and exposes the flexible printed wiring board material 28 continuously on the conveying path which sets a continuous planar surface, when carrying out, for example, so-called planar exposure processing in which a two-dimensional pattern is illuminated by a two-dimensional spatial modulating element (DMD), the planarity of the flexible printed wiring board material 28 is high even if the exposure region has its width in the direction of feeding the flexible printed wiring board material 28. Therefore, it is possible to make the focal length not vary in the substrate feeding direction within the exposure region, and a good image can be obtained.

Further, on the conveying path of the conveying portion 26 for scanning equipped with a unit for detection, good planarity can be ensured due to the flexible printed wiring board material 28 being suctioned to the endless belt 33. Therefore, no tension which pulls in the conveying direction is applied to the flexible printed wiring board material 28 itself, and it is possible to prevent the flexible printed wiring board material 28 from extension/contraction deforming due to tension. Accordingly, in the conveying portion 26 for scanning equipped with a unit for detection which is structured in this way, it is possible to prevent the exposed image from becoming offset (so-called exposure position offset) when the flexible printed wiring board material 28 is subjected to exposure processing in a state in which it is elastically extension/contraction deformed due to tension, and thereafter, the applied tension is released and the flexible printed wiring board material 28 returns to its original shape.

In this image-drawing device, the exhaust air of the blower 37 is passed through a precise air conditioner 39 such that dust is removed therefrom, and thereafter, is recirculated within a clean room in which the image-drawing device is set. To this end, the other end of an exhaust pipe 41, whose one end is connected to the air outlet of the blower 37, is connected to the air inlet side of the precise air conditioner 39.

Owing to such a structure, the air, which the blower 37 suctions from the suction box 35 in order to suck the flexible printed writing board material 28 onto the endless belt 33, passes through the exhaust pipe 41 and is regenerated in the precise air conditioner 39. Although not illustrated, the precise air conditioner 39 purifies, by a so-called HEPA filter, the air fed from the blower 37 or air which is suctioned-in from the interior of the housing of the image-drawing device, and circulates it within the clean room.

When a large quantity of air fed from the blower 37 is exhausted to the exterior of the clean room, the air conditioning ability for supplying fresh, clean air into the clean room must be great, and costs increase. However, with the above-described structure, such a problem can be prevented, and it is also possible to prevent dust from the blower 37 from contaminating the clean room as would be the case if the exhaust air of the blower 37 were exhausted as is into the clean room.

Further, on the conveying path of the conveying portion 26 for scanning equipped with a unit for detection, a guide roller 38 is disposed at the upstream side of the nip roller pair 30, and a guide roller 40 is disposed at the downstream side of the nip driving roller pair 32.

As shown in FIG. 2, a calibration scale 42, which is a calibration member, is disposed at the outer side of the nip roller pair 30 at the conveying portion 26 for scanning equipped with a unit for detection, at a predetermined position on an extended line at the conveying direction upstream side of the conveying path for exposure of the flexible printed wiring board material 28 which is set within the conveying portion 26 for scanning equipped with a unit for detection (i.e., on the same plane as the plane of photographing alignment marks M formed on the flexible printed wiring board material 28, on the conveying path for exposure within the conveying portion 26 for scanning equipped with a unit for detection).

Further, beam position detecting devices 44 and exposure surface power measuring devices 45 are disposed at the outer side of the nip driving roller pair 32 at the conveying portion 26 for scanning equipped with a unit for detection, at a predetermined position on an extended line at the conveying direction downstream side of the conveying path for exposure of the flexible printed wiring board material 28 which is set within the conveying portion 26 for scanning equipped with a unit for detection (i.e., on the same plane as the plane of exposure of the exposure area on the conveying path for exposure within the conveying portion 26 for scanning equipped with a unit for detection).

Namely, in the image-drawing device, camera portions 52 of the alignment unit 46 which is an alignment section move relative to the conveying portion 26 for scanning equipped with a unit for detection. The camera portions 52 are set at positions of an area where alignment is carried out on the conveying path for exposure of the flexible printed wiring board material 28 set at the conveying portion 26 for scanning equipped with a unit for detection. The camera portions 52 are set at the position of the calibration scale 42 which is the calibration member provided at the conveying portion 26 for scanning equipped with a unit for detection.

Note that, in the image-drawing device, it suffices that relative movement be accomplished by any form, provided that there is used a relative moving mechanism which can carry out relative movement such that the camera portions 52 and the area where alignment is carried out on the conveying path for exposure correspond to one another, and such that the camera portions 52 and the calibration scale 42 which is the calibration member correspond to one another. For example, as shown in FIGS. 1 through 5, a structure is possible in which the camera portions 52 are fixed and the conveying portion 26 for scanning equipped with a unit for detection is moved by the linear moving mechanism 30 which is the relative moving mechanism. Or, a structure may be used in which the conveying portion 26 for scanning equipped with a unit for detection is fixed such that the position of the area where alignment is carried out and the position of the calibration scale 42 are immobile, and the camera portions 52 can be moved by a relative moving mechanism (not shown) between an alignment mark M photographing position and a calibration scale 42 photographing position.

Moreover, in the image-drawing device, it suffices that any type of relative moving mechanism be used and, further, that relative movement be accomplished by any type of form, provided that relative movement is possible such that respective head assemblies 54 of the exposure head unit 48 and the beam position detecting devices 44 correspond to one another, and such that the respective head assemblies 54 and the exposure surface power measuring devices 45 correspond to one another. For example, as shown in FIGS. 1 through 5, a structure is possible in which the respective head assemblies 54 of the exposure head unit 48 are fixed and the beam position detecting devices 44 are moved to the exposure position and the conveying portion 26 for scanning equipped with the exposure surface power measuring devices 45 is moved to the exposure position. Or, a structure may be used in which the conveying portion 26 for scanning equipped with the beam position detecting devices 44 and the exposure surface power measuring devices 45 is fixed and immobile, and the respective head assemblies 54 of the exposure head unit 48 are moved.

Namely, in the image-drawing device, the linear moving mechanism 20, which serves as a relative moving mechanism which moves the substrate conveying section 22, structures a means which moves the calibration scale 42, the beam position detecting devices 44, and the exposure surface power measuring devices 45 to predetermined positions respectively.

As shown in FIG. 1 and FIG. 2, at the exposure processing section 12, above the substrate conveying section 22, the alignment unit 46 which is the alignment section is disposed at the conveying direction upstream side, and the exposure head unit 48 which serves as the image-drawing unit is disposed at the conveying direction downstream side.

Although not illustrated, the alignment unit 46 which is the alignment section is set by mounting a base portion 50 to a fixing structure such as the housing of the image-drawing device or the like. A pair of parallel rails (not illustrated) are provided at the base portion 50. The plurality of (four in the present embodiment) camera portions 52 are mounted to the rail portions via camera bases which are moved by ball screw mechanisms, such that the camera portions 52 can move in order to make the optical axes of the lens portions match desired positions in the transverse direction of the flexible printed wiring board material 28.

Although not illustrated, at each camera portion 52, the lens portion is provided at the bottom surface of a camera main body, and a ring-shaped flash light source (an LED flash light source) is mounted to the projecting distal end portion of the lend portion. At the camera portion 52, light from the flash light source is irradiated onto the flexible printed wiring board material 28, the reflected light thereof is picked-up at the camera main body via the lens portion, and the end portion or the mark M (shown in FIG. 8) or the like of the flexible printed wiring board material 28 is detected.

Although not illustrated, the exposure head unit 48, which serves as the image-drawing unit and which is disposed at the exposure processing section 12 as shown in FIG. 1 and FIG. 2, is set so as to be mounted to supports which stand erect at the outer sides of the transverse direction both end portions of the flexible printed wiring board material 28 which is being conveyed.

The exposure head unit 48 serving as the image-drawing unit is structured as a laser exposure device. The plurality of head assemblies 54 are disposed in a substantial matrix form of m rows and n columns (in the present embodiment, in two rows and four columns, for a total of eight). The rows of the plural head assemblies 54 are disposed so as to run along the transverse direction of the flexible printed wiring board material 28 (the direction orthogonal to the conveying direction, and corresponding to the direction orthogonal to the scanning direction which is the conveying direction of the flexible printed wiring board material 28).

As shown in FIG. 1, a light source unit 56 is disposed within the image-drawing device main body. Although not illustrated, the light source unit 56 houses a plurality of laser (semiconductor laser) light sources. The light beams exiting from the respective laser light sources are introduced, by optical fibers, into the corresponding head assemblies 54 respectively.

Each head assembly 54 is structured such that, after the light beam introduced therein is modulated by a digital micromirror device (DMD) (not shown) which is a spatial light modulator, the light beam is focused by an autofocus mechanism onto the flexible printed wiring board material 28 and illuminates a two-dimensional pattern (i.e., the head assembly 54 carries out so-called planar exposure processing).

The digital micromirror device (DMD) of each head assembly 54 is controlled in units of dots on the basis of image data at an image processing section of a control unit 5 8, and exposes a dot pattern on the flexible printed wiring board material 28.

The exposure head unit 48, which serves as the image-drawing unit, carries out exposure processing by, while conveying the flexible printed wiring board material 28 at a uniform speed, illuminating onto the flexible printed wiring board material 28 the plural light beams irradiated from the respective head assemblies 54 at predetermined timings. At the time of exposure, the respective head assemblies 54 carry out exposure after the focal points have been adjusted by autofocus mechanisms. Therefore, even if there are some variations in the heightwise position of the flexible printed wiring board material 28 at this time, appropriate exposure processing can be carried out.

Although not illustrated, at the exposure head unit 48, the exposure area exposed by one of the head assemblies 54 is a rectangular region which is inclined at a predetermined angle of inclination with respect to the scanning direction and whose short side runs along the scanning direction. A strip-shaped exposed region is formed by each of the head assemblies 54 on the flexible printed wiring board material 28 which is conveyed in the scanning direction.

The exposure head unit 48 carries out exposure with the exposure area inclined at a predetermined angle of inclination with respect to the scanning direction. Therefore, because the two-dimensionally arranged dot pattern which is exposed is inclined with respect to the scanning direction, the respective dots which are lined-up in the scanning direction pass-through between the dots which are lined-up in the direction intersecting the scanning direction, such that the substantial pitch between dots is narrowed, and therefore, a higher resolution can be achieved.

Moreover, at the image-drawing device, when offset arises in the relative positional relationship between the exposure head unit 48 and the flexible printed wiring board material 28 which is being conveyed, the camera portions 52 photograph the marks M and the like provided on the flexible printed wiring board material 28, and detect the amount of offset in the positions of the flexible printed wiring board material 28 and the exposure head unit 48, and correct the exposure processing by the exposure head unit 48, such that appropriate exposure processing can be carried out on the flexible printed wiring board material 28.

As shown in FIG. 1 and FIG. 2, in order for the image-drawing device to carry out exposure processing continuously while conveying the flexible printed wiring board material 28 on the conveying path set at the exposure processing section 12, the unexposed recording medium supplying section 14 connected to the upstream side of the conveying path of the exposure processing section 12 is provided, and the exposed recording medium collecting section 16 connected to the downstream side of the conveying path of the exposure processing section 12 is provided.

The unexposed recording medium supplying section 14 is structured by a supply reel 60, on which the unexposed, elongated flexible printed wiring board material 28 is wound in the form of a roll, and a spacer tape take-up reel 62 being mounted to a driving unit 64.

The unexposed recording medium supplying section 14 is structured so as to convey the flexible printed wiring board material 28, which is pulled-out from the supply reel 60, to the entrance of the recording medium conveying path of the exposure processing section 12 via a dancer roller mechanism which is a tension setting means for enabling the flexible printed wiring board material 28 to be conveyed while being set along and closely fit planarly to the endless belt 33.

Although not illustrated, a first dancer roller mechanism for adjusting the difference in conveying speeds may be provided between the supply reel 60 and the entrance of the recording medium conveying path of the exposure processing section 12, and a second dancer roller mechanism which is a tension setting means may be disposed via a clean roller.

The dancer roller mechanism is, for example, placed and structured so as to rotate a dancer roller 68 at a portion where the flexible printed wiring board material 28 is made slack in a U-shape between an exit side roller 66 of the unexposed recording medium supplying section 14 and the entrance guide roller 38 of the exposure processing section 12. Note that this dancer roller mechanism may be substituted by a so-called air dancer which is structured so as to suction the flexible printed wiring board material 28 by air. Further, the second dancer roller mechanism which is the tension setting means is structured so as to apply the relatively weak tension needed in order to make the flexible printed wiring board material 28 tightly contact the endless belt 33 planarly.

Due to the driving unit 64 rotating and driving the supply reel 60, the unexposed recording medium supplying section 14 which is structured in this way pulls the flexible printed wiring board material 28 out and conveys it, via the dancer roller mechanism, in between the endless belt 33 and the nip roller pair 30 of the exposure processing section 12, and continuously supplies the flexible printed wiring board material 28 such that it does not slide on the endless belt 33 on the conveying path.

At the supply reel 60, a spacer tape 61 is nipped and wound between the layers of the wound flexible printed wiring board material 28, such that the layers do not contact one another directly. Therefore, at the unexposed recording medium supplying section 14, the spacer tape take-up reel 62 is rotated and driven by the driving unit 64 such that the spacer tape 61, which extends out together with the flexible printed wiring board material 28 which is being conveyed out, is taken-up onto the spacer tape take-up reel 62.

The exposed recording medium collecting section 16 is structured such that a take-up reel 70, which takes-up the exposed, elongated flexible printed wiring board material 28, and a spacer tape supply reel 72, are mounted to a driving unit 74.

At the exposed recording medium collecting section 16, the exposed flexible printed wiring board material 28 conveyed out from the exposure processing section 12 is taken-up onto the take-up reel 70 via a dancer roller mechanism which serves as a tension setting means and is connected to the exit of the recording medium conveying path of the exposure processing section 12.

The dancer roller mechanism is, for example, placed and structured so as to rotate the dancer roller 68 at a portion where the flexible printed wiring board material 28 is made slack in a U-shape between a holding roller 76 disposed at the conveying direction downstream side of the exit guide roller 40 of the exposure processing section 12, and an entrance side roller 78 of the exposed recording medium collecting section 16.

At the exposed recording medium collecting section 16, a nip roller pair 80 is set between the entrance side roller 78 and the take-up reel 70. Tension, which works due to the exposed flexible printed wiring board material 28 being pulled in order to be taken-up by the take-up reel 70, is absorbed at the nip roller pair 80, and tension is not transferred to the dancer roller mechanism disposed at the conveying path upstream side of the exposed recording medium collecting section 16.

The exposed recording medium collecting section 16 which is structured in this way is structured such that, due to the driving unit 74 rotating and driving the take-up reel 70, the flexible printed wiring board material 28 fed-out from the exposure processing section 12 via the dancer roller mechanism is continuously taken-up and collected.

At the exposed recording medium collecting section 16, at the time of taking-up the flexible printed wiring board material 28 onto the take-up reel 70, the spacer tape 61 is nipped and wound between the wound surfaces such that the layers of the flexible printed wiring board material 28 wound on the supply reel 60 do not contact one another directly. Thus, at the exposed recording medium collecting section 16, the spacer tape supply reel 72 is rotated by the driving unit 74 in order to pull the spacer tape 61 out from the spacer tape supply reel 72 such that the spacer tape 61 can be wound while being made to run along the flexible printed wiring board material 28 which is conveyed-in.

As shown in FIG. 1 and FIG. 2, in the image-drawing device of the above-described structure, a belt conveying mechanism is provided between the nip driving roller pair 32 and the nip roller pair 30 of the conveying path for exposure of the exposure processing section 12.

At the conveying path for exposure of the exposure processing section 12, exposure processing is carried out by the exposure head unit 48 while the portion of the flexible printed wiring board material 28 conveyed on the endless belt 33 of this belt conveying mechanism is conveyed in a main traveling direction (main scanning direction) at a predetermined speed by the rotating driving force of the nip driving roller pair 32, integrally in a state of being suctioned to the surface of the endless belt 33, due to the blower 37 being driven and the action of the air within the semi-closed space enclosed by the endless belt 33 and the suction box 35 being suctioned and being suctioned from the holes 33A for suction of the endless belt 33.

When exposure processing is carried out at the exposure processing section 12, the flexible printed wiring board material 28 is supported planarly by the endless belt 33 at a position corresponding to beneath the alignment unit 46 and at a position corresponding to beneath the exposure head unit 48, on the conveying path for exposure. Note that the flexible printed wiring board material 28, which is stretched on the conveying path for exposure of the exposure processing section 12, is held stably and without slack on the endless belt 33 by the working of a predetermined tension due to the dancer roller mechanism disposed at the conveying direction upstream side and the dancer roller mechanism disposed at the conveying direction downstream side.

Accordingly, the exposure processing section 12 can, by the respective head assemblies 54 of the exposure head unit 48, carry out exposure processing correctly in a two-dimensional pattern, on the surface of the flexible printed wiring board material 28 which is held planarly at the endless belt 33.

Further, at the exposure processing section 12, exposure processing can be carried out continuously by the exposure head unit 48 on the flexible printed wiring board material 28 which is being conveyed at a uniform speed in the main traveling direction. Therefore, it is possible to eliminate the operation of reciprocally operating the flexible printed wiring board material 28 directly beneath the exposure head unit 48, and it is possible to improve the operational efficiency by carrying out exposure processing quickly and in a streamlined manner.

Further, in the image-drawing device, on the basis of the positional data of the marks M or the end portions obtained by the alignment unit 46 picking-up the flexible printed wiring board material 28, the control unit 58 determines an exposure start position for the time of exposure processing by the exposure head unit 48, and a correction coefficient relating to shift positions of dots in the transverse direction of the flexible printed wiring board material 28. Then, on the basis of this correction coefficient, the control unit 58 carries out control so as to correct factors such as the two-dimensional image-drawing patterns or the image recording start times or the like by the respective head assemblies 54 of the exposure head unit 48 and so as to carry out exposure processing, such that the position of the image exposed on the flexible printed wiring board material 28 is corrected to the appropriate position.

At the exposure processing section 12 of the image-drawing device, the portion which is the object of detection of the flexible printed wiring board material 28 directly beneath the alignment unit 46, and the portion which is the object of detection of the flexible printed wiring board material 28 directly beneath the exposure head unit 48, both receive the same tension and are conveyed at the same speed in the main traveling direction (the main scanning direction). Therefore, because the results of detection of the alignment unit 46 can be utilized at the exposure head unit 48 without error, the accuracy of the exposure processing can be improved even more.

Next, the calibration processes of the alignment unit 46 used in the image-drawing device will be explained. At the image-drawing device, alignment is carried out by the alignment unit 46 in order to correctly adjust the relative positional relationship between the flexible printed wiring board material 28 and the exposure head unit 48.

In the alignment processing of the image-drawing device, when size data of the flexible printed wiring board material 28 is inputted at an inputting section (not shown), on the basis of the inputted size data, the positions of the camera portions 52 of the alignment unit 46 are moved and adjusted so as to suit transverse direction positions of the flexible printed wiring board material 28.

At the image-drawing device, a predetermined range in the longitudinal direction of the flexible printed wiring board material 28 which is moving in the main scanning direction is photographed by the respective camera portions 52, the marks M formed in advance for exposure position detection on the flexible printed wiring board material 28 are detected, the marks M are compared with reference positions of the respective camera portion 52, and correction data for exposure is generated. On the basis of this correction data, the exposure processing operation is carried out by using, for example, a pulse counter (not shown), by aiming for the timing at which the exposure start position of the flexible printed wiring board material 28 reaches the exposure beam illumination position of the exposure head unit 48.

Further, in the image-drawing device, in order to aim for proper alignment, position calibration of the camera portions 52 for alignment is carried out. In this position calibration of the camera portions 52 for alignment, position calibration is carried out by using the calibration scale 42.

To this end, at the image-drawing device, the linear moving mechanism 20 is driven such that the entire substrate conveying section 22 (at which the moving table 21, the Z stage 24 for substrate thickness adjustment, the nip roller pair 30, and the nip driving roller pair 32 are provided, and the conveying section 26 for scanning at which the calibration scale 42 is provided) is moved from an exposure standby position shown in FIG. 2 toward the right in FIG. 2, and is set at a position for alignment camera calibration which is shown in FIG. 3.

Namely, in the image-drawing device, the conveying portion 26 for scanning equipped with the calibration scale 42 and disposed at the substrate conveying section 22, is moved, by the linear moving mechanism 20 which moves the substrate conveying section 22, so that the calibration scale 42 coincides with the camera portions 52.

At the position for alignment camera calibration shown in FIG. 3, the respective camera portions 52 and the calibration scale 42 corresponding thereto are in a state of opposing one another. In this state, on the basis of transverse position information of the alignment marks M which is designated, the camera portions 52 for alignment are moved in the transverse direction of the substrate.

The image-drawing device is structured such that the calibration scale 42 is disposed further toward the camera portions 52 than the conveying path of the flexible printed wiring board material 28. Therefore, position calibration of the camera portions 52 for alignment can be carried out in the state in which the flexible printed wiring board material 28 has been conveyed onto the conveying path of the conveying portion 26 for scanning equipped with a unit for detection. Namely, in the image-drawing device, position calibration of the camera portions 52 for alignment can be carried out without removing the flexible printed wiring board material 28 from the conveying path of the conveying portion 26 for scanning equipped with a unit for detection.

In the image-drawing device, the calibration scale 42 is photographed by the camera portions 52 for alignment, and the positional relationships between the calibration scale 42 and the camera portions 52 are calibrated from the positions at which the pattern of the calibration scale 42 was photographed.

Note that, in the image-drawing device, after the alignment camera calibration operation is completed, the linear moving mechanism 20 is driven, and the entire substrate conveying section 22 is returned from the position for alignment camera calibration shown in FIG. 3 to the exposure standby position shown in FIG. 2.

Next, explanation will be given of the calibration means which is used in the image-drawing device, and which relates to the exposure positions of the respective head assemblies 54 and the power distribution within the exposure region.

In the image-drawing device, first, in order to measure the beam positions of the respective head assemblies 54, the conveying portion 26 for scanning equipped with a unit for detection is moved from the exposure standby position shown in FIG. 2 toward the left in the drawings to a beam position detecting position shown in FIG. 4 at which the respective head assemblies 54 and the beam position detecting devices 44 corresponding thereto oppose one another.

In the image-drawing device, in the same way as at the above-described time of moving the calibration scale 42 to the camera portions 52, the beam position detecting devices 44, which are set at the conveying portion 26 for scanning equipped with a unit for detection of the substrate conveying section 22, are moved so as to coincide with the respective head assemblies 54, by the linear moving mechanism 20 which moves the substrate conveying section 22.

Then, the beam positions of the respective head assemblies 54 are measured by the beam position detecting devices 44, and the exposure positions of the head assemblies 54 are calibrated.

Next, at the image-drawing device, in order to measure the power distribution within the exposure region of each head assembly 54, the conveying portion 26 for scanning equipped with a unit for detection is moved from the beam position detecting position shown in FIG. 4 toward the left in the drawings to an exposure surface power calibrating position at which the head assemblies 54 and the exposure surface power measuring devices 45 corresponding thereto oppose one another.

Note that, in the image-drawing device, in the same way as at the above-described time of moving the calibration scale 42 to the camera portions 52, the exposure surface power measuring devices 45, which are set at the conveying portion 26 for scanning equipped with a unit for detection of the substrate conveying section 22, are moved so as to coincide with the respective head assemblies 54, by the linear moving mechanism 20 which moves the substrate conveying section 22.

Then, the power distributions within the exposure regions of the respective head assemblies 54 are measured by the corresponding exposure surface power measuring devices 45, and the powers in all of the exposure regions are calibrated, and image-drawing of an appropriate two-dimensional pattern can be carried out.

The image-drawing device is structured such that the beam position detecting devices 44 and the exposure surface power measuring devices 45 are disposed further toward the exposure head unit 48 than the conveying path of the flexible printed wiring board material 28. Therefore, even in a state in which the flexible printed writing board material 28 has been conveyed onto the conveying path of the conveying portion 26 for scanning equipped with a unit for detection, the flexible printed wiring board material 28 is not interposed between the respective head assemblies 54 and the beam position detecting devices 44 or the exposure surface power measuring devices 45. Therefore, calibration of the exposure positions of the respective head assemblies 54, and power calibration at all of the exposure regions of the respective head assemblies 54, can be carried out. Namely, in the image-drawing device, calibration of the exposure positions of the respective head assemblies 54, and power calibration at all of the exposure regions of the respective head assemblies 54, can be carried out without removing the flexible printed wiring board material 28 from the conveying path of the conveying portion 26 for scanning equipped with a unit for detection.

Further, in the image-drawing device, after the operation of calibrating the exposure positions of the respective head assemblies 54 and the operation of calibrating the powers at all of the exposure regions are completed, the linear moving mechanism 20 is driven, and the entire substrate conveying section 22 is returned from the exposure surface power calibrating position shown in FIG. 5 to the exposure standby position shown in FIG. 2.

In the image-drawing device, at the time of carrying out the alignment camera calibration operation or the operation of calibrating the exposure positions or the operation of calibrating the powers at all of the exposure regions as described above, the flexible printed wiring board material 28 on the conveying path of the conveying portion 26 for scanning equipped with a unit for detection must be restrained so as to not move. Therefore, in the image-drawing device, at the time when the conveying portion 26 for scanning equipped with a unit for detection is moved, the blower 37 of the suction means is driven, the air within the semi-closed space enclosed by the suction box 35 is suctioned, and air is suctioned from the holes 33A for suction of the endless belt 33 which is braked. Due to this operation, the flexible printed wiring board material 28 is set in a state of being suctioned to the surface of the endless belt 33 which is stationary, and the flexible printed wiring board material 28 is held in an immobile state on the conveying path of the conveying portion 26 for scanning equipped with a unit for detection. Or, the image-drawing device may be structured such that, at the time when the conveying portion 26 for scanning equipped with a unit for detection is moved, the nip roller pair 30 at the conveying direction upstream side of the conveying portion 26 for scanning equipped with a unit for detection is braked, the flexible printed wiring board material 28 nipped between the nip roller pair 30 is restrained, the nip driving roller pair 32 at the conveying direction downstream side of the conveying portion 26 for scanning equipped with a unit for detection is braked, and the flexible printed wiring board material 28 nipped between the nip roller pair 30 is restrained.

Next, description will be given of the processing operations in the image-drawing device when the flexible printed wiring board material 28, which is an elongated, strip-shaped, flexible recording medium connected in a series and wound in the form of a roll on the supply reel 60, includes plural types having different alignment mark positions.

When the one flexible printed wiring board material 28 includes plural types having different alignment mark positions in this way, the image-drawing device carries out position calibration of the camera portions 52 for alignment by using the calibration scale 42 as described above, in order to make the respective camera portions 52 correspond to the different alignment mark M positions formed on the flexible printed wiring board material 28, each time at the stage before starting the image-drawing processing of another type at which the positions of the alignment marks formed on the flexible printed wiring board material 28 are at different positions.

Namely, in the image-drawing device, even in a case in which the flexible printed wiring board material 28 cannot be removed from the conveying path of the conveying portion 26 for scanning equipped with a unit for detection because it is in the midst of exposure processing one roll of the flexible printed wiring board material 28 wound on the supply reel 60, the calibration scale 42 can be moved to the image pickup positions of the camera portions 52 for alignment. Therefore, even in a case in which the one flexible printed wiring board material 28 includes plural types whose alignment mark M positions are different, for each different type, position calibration of the camera portions 52 for alignment is carried out, the data of the reference positions of the camera portions 52 are calibrated, the alignment is adjusted with high accuracy, and exposure processing can be carried out at the respective head assemblies 54.

In the image-drawing device, the beam position detecting devices 44 or the exposure surface power measuring devices 45 can be moved to the exposure areas of the respective head assemblies 54, without removing the flexible printed wiring board material 28 from the conveying path of the conveying portion 26 for scanning equipped with a unit for detection. Therefore, even in a case in which plural types whose alignment mark M positions are different are included in the one flexible printed wiring board material 28, appropriate beam position calibration and exposure surface power calibration are carried out, and exposure processing can be carried out at each head assembly 54.

Further, by using the mechanism which moves the calibration scale, the exposure beam position measuring means can be moved relative to the exposure heads. Calibration of the beam positions can therefore be carried out even in the midst of exposing one roll.

Next, description will be given of the workings and operations of the image-drawing device which is structured as described above.

In the image-drawing device, before exposure processing is started, the above-described processing for calibrating the alignment camera portions 52, and calibration of the exposure positions and the power distributions within the exposure regions of the respective head assemblies 54, are carried out. Note that the processing for calibrating the alignment camera portions 52, and the processings for calibrating the exposure positions and the power distributions within the exposure regions of the respective head assemblies 54, can be executed at any time.

Next, in the image-drawing device, the flexible printed wiring board material 28, which is the object on which exposure processing is to be carried out, is set on the conveying path which passes from the unexposed recording medium supplying section 14 through the exposure processing section 12 and reaches the exposed recording medium collecting section 16. To this end, the flexible printed wiring board material 28 which is the recording medium is taken-out from the supply reel 60 and passed along the conveying path at the exposure processing section 12, and the leading end thereof is fixed to the take-up reel 70.

Thereafter, at the image-drawing device, the supply reel 60 is rotated until it is detected that, at the portion of the flexible printed wiring board material 28 which is set on the conveying path, which portion is between the exit side roller 66 at the supply reel 60 side and the entrance guide roller 38 at the exposure processing section 12 side, the slack has become a predetermined amount (the uppermost limit value of the slack) which is a state in which this portion is the most slack, and the dancer roller 68 is set at the slack portion. Thereafter, when it is detected that the slack has become the lower limit value of the slack amount (the state in which the flexible printed wiring board material 28 is the least slack), adjustment is carried out so as to rotate and drive the supply reel 60 until it is detected that the slack has become the upper limit value of the slack amount.

Next, at the image-drawing device, the nip driving roller pair 32 is rotated and driven until it is detected that, at the portion between the conveying path exit side holding roller 76 of the exposure processing section 12 and the entrance side roller 78 of the exposed recording medium collecting section 16, the slack has become a predetermined amount (the lowermost limit value of the slack) which is a state in which this portion is the least slack, and the dancer roller 68 is set at the slack portion. Thereafter, when it is detected that the slack has become the upper limit value of the slack amount (the state in which the flexible printed wiring board material 28 is the most slack), adjustment is carried out so as to rotate and drive the take-up reel 70 until it is detected that the slack has become the lower limit value of the slack amount.

Next, at the image-drawing device, the nip driving roller pair 32 is rotated and driven, and while the flexible printed wiring board material 28 is conveyed, the surface of the flexible printed wiring board material 28 is photographed by the alignment camera portions 52 at predetermined intervals. When the marks M of the exposure start position, which are provided on the flexible printed wiring board material 28, are photographed (sensed), the nip driving roller pair 32 is stopped and set in a standby state.

Subsequently, at the image-drawing device, the nip driving roller pair 32 is rotated, and when the flexible printed wiring board material 28 has been conveyed a predetermined amount, the alignment camera portions 52 photograph the alignment marks M of a unit exposure region L provided on the flexible printed wiring board material 28 in a previous work process, and measure the positions of the marks M of the unit exposure region L. Measurement of the positions of the marks M of the unit exposure region L is preferably carried out at two or more places within the unit exposure region L in the feeding direction of the flexible printed wiring board material 28 shown in FIG. 8 (four or more places at the perimeter of the unit exposure region L). However, in a case in which the substrate cannot be extension/contraction deformed, two places suffice (at the top and bottom or at the left and right of the unit exposure region L).

Next, when measurement of the positions of the marks M of the unit exposure region L is completed, the control unit 58 carries out, from the measured values of the positions of the marks M of the unit exposure region L, deformation processing of the exposure data so that the image to be exposed corresponds to the extension/contraction deformed state. Note that, at this time, the control unit 58 may carry out processing which also includes image recording position correction (exposure start timing correction).

While the control unit 58 is carrying out the deformation processing of the exposure data, the control unit 58 carries out control for continuously feeding the flexible printed wiring board material 28, and carries out measurement of the positions of the alignment marks M of the next unit exposure region L.

Next, when the control unit 58 completes the deformation processing of the exposure data and the leading end of the unit exposure region L is fed to the position of the exposure head unit 48, the control unit 58 starts exposure by the respective head assemblies 54 onto the flexible printed wiring board material 28. When the trailing end of this unit exposure region L reaches a predetermined position past the exposure head unit 48, the control unit 58 stops the exposure of the unit exposure region L.

This exposure processing is carried out at the time when the unit exposure region L of the flexible printed wiring board material 28 passes through the exposure region exposed by the exposure head unit 48. The exposure processing is carried out by the respective head assemblies 54 illuminating laser light onto the DMDs on the basis of the exposure data subjected to deformation processing at the control unit 58, and the laser lights, which are reflected when the micromirrors of the DMDs are in on states, passing along the optical paths set by the optical systems and being imaged onto the flexible printed wiring board material 28.

The image-drawing device carries out the above-described exposure processing continuously, and stops the nip driving roller pair 32 and ends the exposure processing when the unit exposure regions L have been exposed a number of times designated in advance.

As described above, in the image-drawing device, the flexible printed wiring board material 28 extends so as to be placed on and run along the endless belt 33 of the belt conveying mechanism which spans between the nip roller pair 30 and the nip driving roller pair 32. Due to the nip driving roller pair 32 being rotated at a uniform speed, the flexible printed wiring board material 28 is continuously fed integrally with the endless belt 33. Then, laser exposure is carried out continuously and the image is drawn by the head assemblies 54, on the stretched portion of the flexible printed wiring board material 28 spanning between the nip roller pair 30 and the nip driving roller pair 32 via the endless belt 33. Accordingly, as compared with a structure in which processing for alignment adjustment is carried out on the recording medium on the going journey and exposure processing is carried out on the return trip, the image-drawing device can continuously carry out exposure processing always, and therefore, can improve the produceability.

Next, a structural example of providing guides for the endless belt 33 on the conveying path of the exposure processing section 12 in the above-described image-drawing device, will be described in accordance with FIG. 6.

In the exposure processing section 12 shown in FIG. 6, rotating contacting rollers 84, which serve as an under supporting means, are disposed at positions corresponding to directly beneath the endless belt 33, which positions correspond to the entire exposure processing region by the head assemblies 54 on the conveying path.

The rotating contacting rollers 84 rotate while contacting the bottom surface of the endless belt 33, and guide the endless belt 33 so as to be supported from beneath. As shown in FIG. 6, the rotating contacting rollers 84 are disposed at the conveying direction upstream side and downstream side so as to sandwich the respective exposure processing regions exposed by the head assemblies 54, and are disposed at the conveying direction upstream side and downstream side so as to sandwich the photographing region photographed by the camera portions 52. By disposing the rotating contacting rollers 84 in this way, when air is suctioned from the suction box 35, it is possible to restrain the endless belt 33 from moving so as to be pulled toward the suction box 35 side.

Here, the exposure processing section 12 shown in FIG. 6 may be structured such that, instead of the rotating contacting rollers 84, the planar surface of a suction stage in which a large number of holes of suction are formed slidingly-contacts and guides the reverse side of the endless belt 33, although this structure is not illustrated. In the case of such a structure, the flexible printed wiring board material 28 is suctioned onto the surface of the endless belt 33 by the working of the sucking from the holes 33A for suction of the endless belt 33 which communicate with the large number of holes for suction formed in the suction stage.

Note that, in the structure shown in FIG. 6, separate suction boxes 35 are provided for the portions corresponding to the exposure processing region and the photographing region, respectively.

By providing the rotating contacting rollers 84 in this way, the flexible printed wiring board material 28, which is supported and conveyed by the endless belt 33 on the conveying path, is subjected to exposure processing by the respective head assemblies 54 while being indirectly supported by the rotating contacting rollers 84 from the reverse side of the endless belt 33 and guided such that the planar state thereof is maintained. In the case of such a structure, at the time of exposure processing, the planarity can be maintained with even higher accuracy, and it is possible to prevent the planar surface of the flexible printed wiring board material 28 from varying due to external disturbance. Therefore, exposure processing can be carried out with more stable quality.

Further, when the two rotating contacting rollers 84 are disposed at the reverse surface of the endless belt 33 in a vicinity of the exposure position and the region between these rotating contacting rollers 84 is suctioned by the suction box 35, the sinking-in of the endless belt 33 due to the suction can be kept small, the flexible printed wiring board material 28 is held planar, and a good exposure surface is obtained. Moreover, alignment processing can be carried out appropriately by utilizing a similar structure at the endless belt 33 in a vicinity of the alignment position as well.

Although not illustrated, a structure may be used in which, in addition to providing the rotating contacting rollers 84, which are disposed as the under supporting means, at the positions directly beneath the camera portions 52 and the positions directly beneath the exposure head unit 48, a single or plural guide rollers rotatingly contact an arbitrary position(s) at the reverse side of the endless belt 33 and planarly convey the flexible printed wiring board material 28 while guiding the flexible printed wiring board material 28 so as to maintain the planar state thereof.

Further, in the image-drawing device relating to the present embodiment, even if the structures for sucking the flexible printed wiring board material 28 to the endless belt 33 (i.e., the suction box 35, the holes 33A for suction formed in the endless belt 33, the blower 37, and the like) are eliminated and exposure is carried out while driving the endless belt 33 in a state in which the flexible printed wiring board material 28 is made to run along the surface of the endless belt 33, the focal lengths from the head assemblies 54 can be held constant because the flexible printed wiring board material 28 runs along the endless belt 33 whose planarity is high.

Moreover, in the image-drawing device relating to the present embodiment, even if the dancer roller mechanisms which are the tension setting means are eliminated, if the flexible printed wiring board material 28 is suctioned to the surface of the endless belt 33 and conveyed, good planarity can be ensured even if tension is not applied to the flexible printed wiring board material 28. In the case of this structure, because tension is not applied to the flexible printed wiring board material 28 by tension setting means, the exposure position offset caused by extension and contraction of the flexible printed wiring board material 28 can be made to be small, and the processing for the correction thereof can be simplified.

Note that, in the present embodiment, DMDs are used as the spatial light modulators used at the head assemblies 54 of the exposure head unit 48 which is structured as a laser exposure device, and the dot pattern is generated by turning the DMDs on and off with the periods of the lighting times being constant. However, pulse width modulation in accordance with on time ratio (duty) control may be carried out. Further, the dot pattern may be generated by a number of times of lighting, with the lighting time period each one time being an extremely short time period.

Moreover, in the present embodiment, description is given of the head assemblies 54 having DMDs as spatial light modulators. However, other than such a reflecting-type spatial light modulator, for example, a MEMS (Micro Electro Mechanical System) type spatial light modulator (SLM), or a spatial light modulator other than a MEMS type such as a transmitting-type spatial light modulator (LCD), an optical element which modulates transmitted light in accordance with the electrooptical effect (a PLZT element), a liquid crystal shutter array such as a liquid crystal light shutter (FLC), or the like may be used instead of the DMD. Moreover, a structure in which a plurality of Grating Light Valves (GLVs) are lined-up in a two-dimensional form can be used. In structures using reflecting-type spatial light modulators (GLVs) and transmitting-type spatial light modulators (LCDs), a lamp or the like can be used as the light source, rather than the aforementioned laser.

Further, as the light source in the embodiment, a fiber array light source having a plurality of multiplex laser light sources, a fiber array light source in which are arrayed fiber light sources having a single optical fiber emitting laser light made incident from a single semiconductor laser having one light-emitting point, and a light source in which a plurality of light-emitting points are lined-up in two dimensions (e.g., an LD array, an organic EL array, and the like) can be used.

In the image-drawing device, other than the head assemblies which irradiate a two-dimensional pattern and carry out exposure processing, for example, it is possible to use a laser exposure device which uses a polygon mirror and the like which carry out exposure processing linearly.

Either of a photon-mode photosensitive material on which information is directly recorded by exposure, or a heat-mode photosensitive material on which information is recorded by heat generated by exposure, can be used in the image-drawing device. In a case in which a photon-mode photosensitive material is used, a GaN semiconductor laser, a wavelength converting solid state laser, or the like is used as the laser device. Further, in a case in which a heat-mode photosensitive material is used, an AlGaAs semiconductor laser (infrared laser) or a solid state laser is used as the laser device.

Further, in the above-described embodiment, the flexible printed wiring board material 28 stretched between the nip roller pair 30 and the nip driving roller pair 32 is stretched at a constant tension due to the dancer roller mechanism, which serves as a tension setting means and is disposed at the conveying direction upstream side of the nip roller pair 30, and the dancer roller mechanism, which serves as a tension setting means and is disposed at the conveying direction downstream side of the nip driving roller pair 32. However, the tension setting means which is used here may be structured so as to apply a constant tension by rotating and driving one nip roller pair and another nip roller pair at different speeds, or may be structured so as to apply a constant tension by braking one nip roller pair by a predetermined braking force and conveying by the other nip driving roller pair.

Note that, other than the image-drawing processing of the flexible printed wiring board material 28 which serves as the elongated, strip-shaped, flexible recording medium, the image-drawing device may be structured as a device which carries out image-drawing processing of substrates for displays.

Further, the present invention is not limited to the above description, and may of course assume any of various structures within a range which does not deviate from the gist of the present invention.

In the image-drawing device in which alignment can be calibrated of the present invention, the calibration member may be mounted to the conveying section for scanning such that a surface coincides with a substantially extended plane of the conveying path of the conveying section for scanning.

In accordance with such a structure, in addition to the operation and effects of the above-described second aspect of the present invention, the alignment section can detect the calibration member under the same conditions as detecting the elongated, flexible recording medium which is on the conveying path of the conveying section for scanning. Therefore, troublesome processings such as focal point adjustment and the like can be eliminated.

In the image-drawing device in which alignment can be calibrated of the present invention, the relative moving mechanism may be structured so as to integrally move the conveying section for scanning and the calibration member mounted thereto.

In the image-drawing device in which alignment can be calibrated of the present invention, a restraining mechanism may be provided for restraining the elongated, flexible recording medium which is on the conveying path of the conveying section for scanning, when the relative moving mechanism moves the conveying section for scanning.

In the image-drawing device in which alignment can be calibrated of the present invention, the alignment section may be structured such that a camera portion is mounted to a base portion so as to be able to move in a transverse direction of the elongated, flexible recording medium.

In the image-drawing device in which alignment can be calibrated of the present invention, the alignment section may be structured so as to operate by being automatically controlled by a control unit.

In the image-drawing device in which alignment can be calibrated of the present invention, the image-drawing unit may be structured by a laser exposure device.

In the image-drawing device in which alignment can be calibrated of the present invention, the image-drawing unit may be structured so as to modulate a light beam by a spatial light modulator and carry out exposure processing of a two-dimensional pattern.

In the image-drawing device in which alignment can be calibrated of the present invention, a beam position detecting device and an exposure surface power measuring device may be mounted to the conveying section for scanning, such that surfaces coincide with a substantially extended plane of the conveying path of the conveying section for scanning.

In accordance with such a structure, in addition to the operation and effects of the above-described second aspect of the present invention, by using the beam position detecting device and the exposure surface power measuring device, calibration of the exposure positions of the image-drawing device carrying out exposure processing, and power calibration at all of the exposure regions, can be carried out under the same conditions as those under which image-drawing is carried out by the image-drawing unit on the elongated, flexible recording medium which is on the conveying path of the conveying section for scanning.

In the image-drawing device in which alignment can be calibrated of the present invention, the image-drawing unit may be structured so as to operate by being automatically controlled by a control unit.

In the method of calibrating an alignment section of the present invention, the relative movement may be carried out by integrally moving the calibration member and a conveying section which structures the conveying path.

In the method of calibrating an alignment section of the present invention, the relative movement may be carried out by making a position of a surface of the calibration member coincide with a position of the flexible recording medium at a time of alignment.

In the method of calibrating an alignment section of the present invention, the relative movement may be carried out in a state in which the flexible recording medium is restrained on the conveying path.

In accordance with the above-described method of calibrating an alignment section, the position of the alignment section can be calibrated by using the calibration member, even if the elongated, flexible recording medium is on the conveying path.

In the conveying device of the present invention, the calibration member may be disposed that a surface coincides with a substantially extended plane of the conveying path at the area at which alignment is carried out.

The conveying device of the present invention may be structured such that the calibration member is mounted to the conveying section, and the relative moving mechanism is structured so as to integrally move the calibration member and the conveying section.

In the conveying device of the present invention, a restraining means may be provided for restraining the flexible recording medium at the conveying section, when the relative moving mechanism moves the conveying section.

In accordance with such a structure, the position of the alignment section can be calibrated by using the calibration member, even if the elongated, flexible recording medium is on the conveying path.

In accordance with the method of calibrating an alignment section, the image-drawing device in which alignment can be calibrated, and the conveying device of the present invention, there is the effect that a flexible recording medium, which is formed as a single elongated body and includes plural types which have different positions where alignment marks are provided, can be continuously subjected to image-drawing processing by carrying out alignment adjustment with high accuracy while calibrating the position of an alignment section by using a calibration scale, for each type having different positions where the alignment marks are provided.

1. A method of calibrating an alignment section, comprising:
in a state in which alignment is adjusted by an alignment section and image-drawing is carried out while one, elongated, flexible recording medium which includes plural types of alignment mark positions is conveyed, restraining the flexible recording medium on a conveying path of an image-drawing unit, at a time when the alignment mark positions on the flexible recording medium become different positions;
relatively moving a calibration member and the alignment section, so as to make the calibration member and the alignment section correspond to one another; and
calibrating data of a reference position of the alignment section by using the calibration member.

2. An image-drawing device further comprising:
an alignment section disposed so as to carry out detection for alignment of a flexible recording medium is carried out and which is set on the conveying path;
a calibration member disposed at a position further toward the alignment section than the conveying path; and
a mechanism relatively moving the alignment section and the calibration member, such that the alignment section is set in a state of detecting the calibration member.

3. The image-drawing device in which alignment can be calibrated of claim 2, wherein the calibration member is mounted to the conveying section for scanning such that a surface coincides with a substantially extended plane of the conveying path of the conveying section for scanning.

4. The image-drawing device in which alignment can be calibrated of claim 2, wherein the relative moving mechanism is structured so as to integrally move the conveying section for scanning and the calibration member mounted thereto.

5. The image-drawing device in which alignment can be calibrated of claim 4, wherein a restraining mechanism is provided for restraining the elongated, flexible recording medium which is on the conveying path of the conveying section for scanning, when the relative moving mechanism moves the conveying section for scanning.

6. The image-drawing device in which alignment can be calibrated of claim 2, wherein the alignment section is structured such that a camera portion is mounted to a base portion so as to be able to move in a transverse direction of the elongated, flexible recording medium.

7. The image-drawing device in which alignment can be calibrated of claim 2, wherein the alignment section is structured so as to operate by being automatically controlled by a control unit.

8. The image-drawing device in which alignment can be calibrated of claim 2, wherein the image-drawing unit is structured by a laser exposure device.

9. The image-drawing device in which alignment can be calibrated of claim 2, wherein the image-drawing unit is structured so as to modulate a light beam by a spatial light modulator and carry out exposure processing of a two-dimensional pattern.

10. The image-drawing device in which alignment can be calibrated of claim 8, wherein a beam position detecting device and an exposure surface power measuring device are mounted to the conveying section for scanning, such that surfaces coincide with a substantially extended plane of the conveying path of the conveying section for scanning.

11. The image-drawing device in which alignment can be calibrated of claim 2, wherein the image-drawing unit is structured so as to operate by being automatically controlled by a control unit.

12. A method of calibrating an alignment section in a conveying device of an elongated, flexible recording medium, the method comprising:
in a state in which the flexible recording medium is set at a conveying path, relatively moving the alignment section and a calibration member, which is disposed at a position further toward the alignment section than the conveying path, and making positions of the alignment section and the calibration member correspond to one another; and
carrying out position calibration of the alignment section by using the calibration member.

13. The method of calibrating an alignment section of claim 12, wherein the relative movement is carried out by integrally moving the calibration member and a conveying section which structures the conveying path.

14. The method of calibrating an alignment section of claim 13, wherein the relative movement is carried out by making a position of a surface of the calibration member coincide with a position of the flexible recording medium at a time of alignment.

15. The method of calibrating an alignment section of claim 13, wherein the relative movement is carried out in a state in which the flexible recording medium is restrained on the conveying path.

16. A conveying device of an elongated, flexible recording medium, comprising:
a conveying section conveying the flexible recording medium in a given conveying direction;
an alignment section disposed so as to be able to carry out detection at a position of an area at which alignment is carried out and which is set on a conveying path along which the flexible recording medium is conveyed by the conveying section;
a calibration member disposed at a position further toward the alignment section than the conveying path; and
a relative moving mechanism relatively moving the alignment section and the calibration member, such that the alignment section is set in a state of detecting the calibration member.

17. The conveying device of claim 16, wherein the calibration member is disposed that a surface coincides with a substantially extended plane of the conveying path at the area at which alignment is carried out.

18. The conveying device of claim 16, wherein the calibration member is mounted to the conveying section, and
the relative moving mechanism is structured so as to integrally move the calibration member and the conveying section.

19. The conveying device of claim 18, wherein a restraining mechanism is provided for restraining the flexible recording medium at the conveying section, when the relative moving mechanism moves the conveying section.
